(19) United States
(12) Patent Application Publication
(10) Pub. No.: US 2024/0202200 A1
(43) Pub. Date: Jun. 20, 2024

(54) EVALUATION METHOD

(71) Applicant: NEC Corporation, Minato-ku, Tokyo (JP)

(72) Inventors: Naoki Sawada, Tokyo (JP); Yuri Satou, Tokyo (JP); Kenji Fukuda, Tokyo (JP)

(73) Assignee: NEC Corporation, Minato-ku, Tokyo (JP)

(21) Appl. No.: 17/909,817

(22) PCT Filed: Mar. 30, 2020
(86) PCT No.: PCT/JP2020/014496

§ 371 Date: Sep. 7, 2022

(51) Int. Cl. G06F 16/2457

(52) U.S. Cl. CPC G06F 16/24575

(57) ABSTRACT

An evaluation apparatus 100 according to the present invention includes acquisition means 121 that acquires desire data including information on a desired animal, which is an animal that a user desires to keep, and information on the user and evaluation means 122 that inputs the desire data to a model, the model being generated by learning learning data including information on kept animals, which are animals kept by keepers, and information on the keepers, and calculates an evaluation value indicating an evaluation of keeping of the animal by the user on the basis of information calculated by the model.

### TECHNICAL FIELD

The present invention relates to an evaluation method, evaluation apparatus, and program that evaluate keeping of an animal by a user.

### BACKGROUND ART

Users who desire to keep a pet such as a dog or cat may search for a pet by actually meeting pets at a pet shop or by using a matching system as described in Patent Document 1. The matching system of Patent Document 1 provides a database storing pet information such as the species, age, sex, and images of pets and keeper information such as the names and addresses of keepers who provide pets, and users can search for a pet using the database.
Patent Document 1: Japanese Unexamined Patent Application Publication No. 2015-76082

### SUMMARY OF INVENTION

However, the matching system only searches for candidate pet animals using information on animals desired by users. This results in the problem that animal selection more suitable for both users and animals is not necessarily made.

Accordingly, an object of the present invention is to provide an evaluation method, evaluation apparatus, and program capable of solving the above problem, that is, the problem that animal selection more suitable for both users and animals is not necessarily made.

An evaluation method according to one aspect of the present invention includes acquiring desire data including information on a desired animal being an animal that an user desires to keep and information on the user; and inputting the desire data to a model, the model being generated by learning learning data including information on a kept animal being an animal kept by a keeper and information on the keeper, and calculating an evaluation value indicating an evaluation of keeping of the animal by the user on the basis of information calculated by the model.

An evaluation apparatus according to another aspect of the present invention includes acquisition means configured to acquire desire data including information on a desired animal being an animal that an user desires to keep and information on the user and evaluation means configured to input the desire data to a model, the model being generated by learning learning data including information on a kept animal being an animal kept by a keeper and information on the keeper, and to calculate an evaluation value indicating an evaluation of keeping of the animal by the user on the basis of information calculated by the model.

A program according to yet another aspect of the present invention causes an information processing apparatus to function as acquisition means configured to acquire desire data including information on a desired animal being an animal that an user desires to keep and information on the user and evaluation means configured to input the desire data to a model, the model being generated by learning learning data including information on a kept animal being an animal kept by a keeper and information on the keeper, and to calculate an evaluation value indicating an evaluation of keeping of the animal by the user on the basis of information calculated by the model.

The present invention thus configured allows for animal selection more suitable for both users and animals.

### BRIEF DESCRIPTION OF DRAWINGS

FIG. 1 is a block diagram showing a configuration of an evaluation apparatus according to a first example embodiment of the present invention;

FIG. 2 is a diagram showing an example of information processed by the evaluation apparatus disclosed in FIG. 1;

FIG. 3 is a diagram showing an example of information processed by the evaluation apparatus disclosed in FIG. 1;

FIG. 4 is a diagram showing the state of a process performed by the evaluation apparatus disclosed in FIG. 1;

FIG. 5 is a diagram showing the state of a process performed by the evaluation apparatus disclosed in FIG. 1;

FIG. 6 is a diagram showing the state of a process performed by the evaluation apparatus disclosed in FIG. 1;

FIG. 7 is a flowchart showing an operation of the evaluation apparatus disclosed in FIG. 1;

FIG. 8 is a block diagram showing a hardware configuration of an evaluation apparatus according to a second example embodiment of the present invention;

FIG. 9 is a block diagram showing a configuration of the evaluation apparatus according to the second example embodiment of the present invention; and

FIG. 10 is a flowchart showing an operation of the evaluation apparatus according to the second example embodiment of the present invention.

### EXAMPLES EMBODIMENTS

### First Example Embodiment

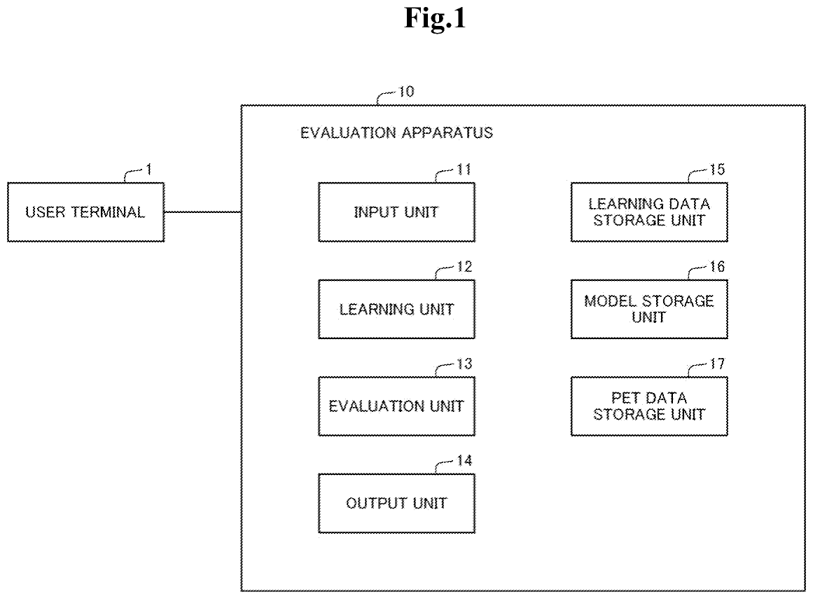

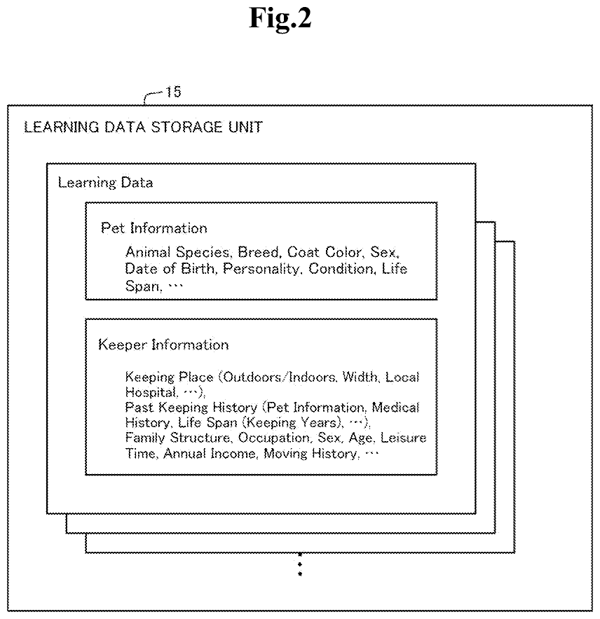

A first example embodiment of the present invention will be described with reference to FIGS. 1 to 7. FIG. 1 is a diagram showing a configuration of an evaluation apparatus, and FIGS. 2 to 7 are diagrams showing a process operation of the evaluation apparatus.

### Configuration

An information processing system according to the present example embodiment aims to evaluate candidate animals for users who desire to keep an animal and can become an animal keeper. In the present example embodiment, for example, a higher evaluation value is calculated when it is determined that an animal will live longer. This is because it seems that the animal and user will feel a higher level of happiness. Note that the information processing system may evaluate candidate animals for users on the basis of a different criterion. While an example in which animals to be evaluated are animals generally kept as pets, such as dogs or cats, is described in the present example embodiment, the animals to be evaluated may be any type of animals.

As shown in FIG. 1, the information processing system according to the present example embodiment includes an evaluation apparatus 10 and a user terminal 1 connected to the evaluation apparatus through a network. The user terminal 1 is an information processing terminal, such as a smartphone or personal computer, operated by a user who desires to keep an animal and can become a keeper. The evaluation apparatus 10 has a function of receiving access from the user terminal 1, evaluating candidate animals that may be kept by the user, and providing information including the evaluations to the user terminal 1.

The evaluation apparatus 10 consists of one or more information processing apparatuses each including an arithmetic logic unit and a storage unit. As shown in FIG. 1, the evaluation apparatus 10 includes an input unit 11, a learning unit 12, an evaluation unit 13, and an output unit 14. The functions of the input unit 11, learning unit 12, evaluation unit 13, and output unit 14 are implemented when the arithmetic logic unit executes a program for implementing the functions stored in the storage unit. The evaluation apparatus 10 also includes a learning data storage unit 15, a model storage unit 16, and a pet data storage unit 17. The learning data storage unit 15, model storage unit 16, and pet data storage unit 17 are included in the storage unit. The respective elements will be described in detail below.

The input unit 11 (input means) receives input of learning data from the operator of the evaluation apparatus 10, or a different server and stores the learning data in the learning data storage unit 15. The learning data is information consisting of many cases in which keepers have actually kept animals. An example of the learning data is shown in FIG. 2. This learning data includes “pet information,” which is information on animals kept by keepers in the past, and “keeper information,” which is information on the keepers.

Examples of the “pet information” include the species, breed, coat color, sex, date of birth, personality, condition, life span, biometric information (any information obtainable by a biometric sensor such as a microchip, including blood pressure, temperature, heartbeat, and sleep state), and health information (checkup results, visit history, medical history, chronic disease, medications taken, treatment received, etc.) of the kept animals and evaluation comments on the kept animals made by the keepers (preferences (favorite food, like/dislike of exercise, etc.) of the kept animals).

The “keeper information” includes the keeping place-related information (outdoors/indoors, region, regional weather (clear or rainy, temperature, humidity, amount of ultraviolet rays, width, local hospital, etc.), past keeping history (pet information (species, breed, etc.), medical history, life span (keeping years), etc.), family structure, occupation, sex, age, leisure time, annual income, and moving history of the keepers of the animals.

Note that the learning data is not limited to the above-mentioned information and may be a part of the information or may include other information.

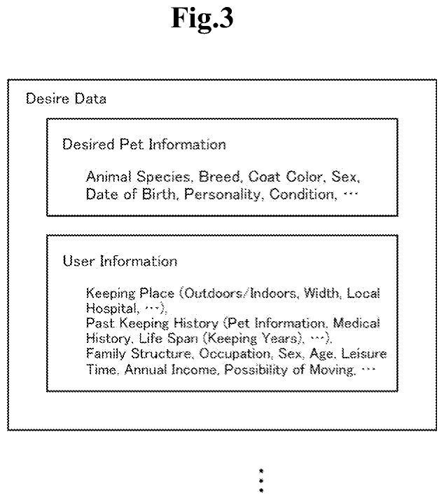

The input unit 11 (acquisition means) receives input of desire information from the user of the user terminal 1 who desires to newly keep an animal and can become a keeper and acquires the desire data. An example of the desire data is shown in FIG. 3. The desire data includes “desired pet information,” which is information on a desired animal that the user desires to keep, and “user information,” which is information on the user.

For example, the “desired pet information” includes animal species (species information), breed, coat color, sex, date of birth, personality, condition, and the like as attribute information indicating the attributes of the animal that the user desires to keep.

The “user information” includes keeping place (outdoors/indoors, width, local hospital, etc.), past keeping history (pet information (species, breed, etc.), medical history, life span (keeping years), etc.), family structure, occupation, sex, age, leisure time, annual income, the possibility of moving, and the like as keeping information indicating the keeping status of the user who desires to keep the animal.

Note that the desire data is not limited to the above-mentioned information and may be a part of the information or may include other information.

The input unit 11 (evaluation means) then inputs the desire data received from the user terminal 1 to a model generated as described later. At this time, the input unit 11 may input the desire data to the model as it is, or may change information on some items of the desire information and input the resulting information to the model. For example, the input unit 11 generates multiple pieces of desire data by changing some items of the “desired pet information” in the desire data, that is, attribute information of the animal desired by the user and inputs the pieces of desire data to the model. For example, it is assumed that the user inputs desire data including desired pet information “animal species: dog, breed: Shiba Inu, coat color: brown, sex: male, and the like.” In this case, the input unit 11 uses this desire data as one piece of desire data without changing the desired pet information, as well as generates another piece of desire data by changing the sex as seen in “animal species: dog, breed: Shiba Inu, coat color: brown, sex: female, and the like” and also generates yet another piece of desire data by changing the breed as seen in “animal species: dog, breed: Akita Inu, coat color: brown, sex: male, and the like.” The input unit 11 then inputs the pieces of desire data to the model.

Also, for example, the input unit 11 generates multiple pieces of desire data by changing information on some items of the “user information” in the desire data and inputs the pieces of desire data to the model. For example, it is assumed that the user inputs desire data including user information “keeping place (outdoors/indoors, width, local hospital, etc.), past keeping history (pet information (species, breed, etc.), medical history, life span (keeping years), etc.), family structure, occupation, sex, age, leisure time, annual income, the possibility of moving (three-years-later transfer), and the like.” In this case, the input unit 11 uses this desire data as one piece of desire data without changing the user information, as well as changes an item such as keeping place (outdoors/indoors, width, local hospital, etc.), age, or family structure to other information in accordance with the information “possibility of moving (three-years-later transfer)” to generate three-years-later and five-years-later user information, and generates pieces of desire data including the respective pieces of user information. The input unit 11 then inputs the pieces of desire data to the model. Note that the changed items of the user information are information predicted by the input unit 11 from other information in the user information or information predicted by the input unit from information accumulated thus far. For example, if the information “possibility of transfer” includes information indicating that the type of transfer destination residence is condominium or information on the transfer destination address, the information “keeping place” can be predicted from such information.

The input unit 11 also receives input of knowledge information, which is information on animals, from experts on animals such as veterinarians. The knowledge information is, for example, information such as the typical life span of each animal species or breed or diseases to which animals are susceptible. As will be described later, the knowledge information is used when the evaluation unit 13 calculates an evaluation value or when the reliability of a model to be generated is checked.

The input unit 11 also receives input of desire data from the user. The input unit 11 may receive input of desire data (second desire data) including conditions different from those in already inputted desire data (first desire data). The second desire data is data including conditions obtained by changing some or all of those of the first desire data on the basis of a user operation.

When receiving input of desire data, the input unit 11 may receive data in text format, or may receive a user operation of selecting a desired item from predetermined options, or may receive input as speech data. When the input unit 11 receives input of speech data, the received data is processed by a speech recognition unit (not shown in FIG. 1).

The learning unit 12 performs learning using learning data stored in the learning data storage unit 15, generates a model that predicts the expected life span of the animal to be kept by the user, and stores the model in the model storage unit 16. Specifically, the learning unit 12 learns from cases in which keepers have actually kept animals and generates a model that receives information such as the breed and personality of animals and the keeping place and keeping history of keepers as input data and outputs the life span of an actual animal as output data. The model thus generated by the learning unit 12, upon input of information such as the species and breed of an animal and the keeping place and keeping history of a keeper, outputs the expected life span of the animal.

When the input unit 11 receives input of new desire data from the user and inputs the desire data to the model, the evaluation unit 13 (evaluation means) calculates an evaluation value indicating the evaluation of keeping of the animal by the user on the basis of an output from the model. The term “evaluation value” refers to an evaluation index of the relationship between the user and the animal. Specifically, the evaluation unit 13 acquires the expected life span of the animal outputted from the model that has received input of the desire data from the user and calculates the evaluation value of the user or animal on the basis of the life span. For example, the evaluation unit 13 calculates the evaluation value of the animal using the expected life span of the animal and the predetermined reference life span of an animal of the same species. More specifically, the evaluation unit 13 calculates the evaluation value of the animal using a formula [(the expected life span of the animal)−(the predetermined reference life span of an animal of the same species)] and handles a higher value as a higher evaluation. The predetermined reference life span of the animal is, for example, the typical life span of the animal, which is information received by the input unit 11 and derived from experts, or information previously registered in the evaluation apparatus 10.

The evaluation unit 13 also calculates the evaluation value of the user using, for example, the expected life span of the animal and the number of years of keeping of an animal in the past by the user. For example, the evaluation unit 13 calculates the evaluation value using a formula [(the expected life span of the animal)−(the number of years of keeping of an animal in the past by the user)]. This is because as the expected life span of the animal is longer, the user can expect that the user will keep the animal longer than the number of years of keeping of the animal in the past by the user and thus user satisfaction can be increased. For this reason, when calculating the evaluation value using this formula, the evaluation unit 13 handles a higher evaluation value as a higher evaluation. The number of years of keeping of the animal in the past by the user is, for example, information in the user information in the inputted desire data or information inputted by the user as a response to a questionnaire or the like. Note that the above formula is illustrative only and any calculation method may be used to calculate the evaluation value. Moreover, a higher evaluation value need not necessarily be handled as a higher evaluation.

The evaluation unit 13 may calculate the evaluation value on the basis of the expected life span of the animal outputted from the model that has received input of the desire data from the user. Specifically, the evaluation unit 13 calculates the evaluation value on the basis of the user information on the user, the expected life span of the animal outputted from the model, the predetermined reference life span of an animal of the same species, and the number of years of keeping of the animal of the same species. The evaluation value becomes higher as the number of years of keeping or the life span is longer; the evaluation value becomes lower as the number of years of keeping or the life span is shorter. The number of years of keeping is preferably the number of years of keeping of an animal of the same species in the past by a user having user information similar to that of the user to be evaluated. For this reason, the evaluation unit 13 may also calculate the evaluation value using the user information of the user who has experienced keeping of the animal of the same species in the past. The term “evaluation value” refers to an evaluation index of the relationship between the user and the animal. The evaluation value can be referred to as the level of happiness of the user or animal relating to the goodness of the relationship between the user and the animal, or the degree of matching indicating the goodness of affinity between the user and animal, or the like.

When the input unit 11 generates multiple pieces of desire data from one piece of desire data inputted by one user and then inputs the pieces of desire data to the model as described above, the evaluation unit 13 calculates the evaluation values on the basis of outputs from the model. For example, when item values such as “breed” and “sex” in desired pet information in the desire data are changed and the resulting multiple pieces of desire data are inputted to the model, the evaluation unit 13 calculates evaluation values corresponding to the item value-changed pieces of desire data. Also, for example, when an predetermined item in the user information in the desire data is changed on an elapsed years number basis and the resulting multiple pieces of desire data are inputted to the model, the evaluation unit 13 calculates evaluation values corresponding to the pieces of desire data of the respective numbers of elapsed years.

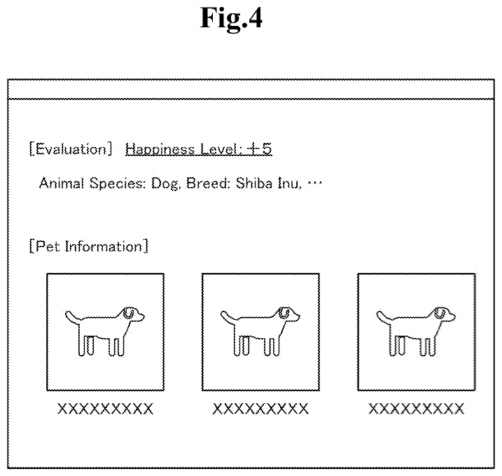

The output unit 14 outputs the evaluation value thus calculated by the evaluation unit 13 to the user terminal 1 to display it on the display unit of the user terminal 1. For example, as shown in FIG. 4, the output unit 14 outputs the calculated evaluation value “happiness level: +5” to display it, as well as outputs all or part of the desire data from which the evaluation value has been calculated to display it. At this time, along with the evaluation value, the output unit 14 may display pet information corresponding to desired pet information in the desire data and indicating information on animals actually being sold at a pet shop. For example, the pet information is previously registered in the evaluation apparatus 10 by a pet shop or the like and stored in the pet data storage unit 17. As seen above, the output unit 14 also has a function of recommending animals suitable for the user on the basis of the evaluation value.

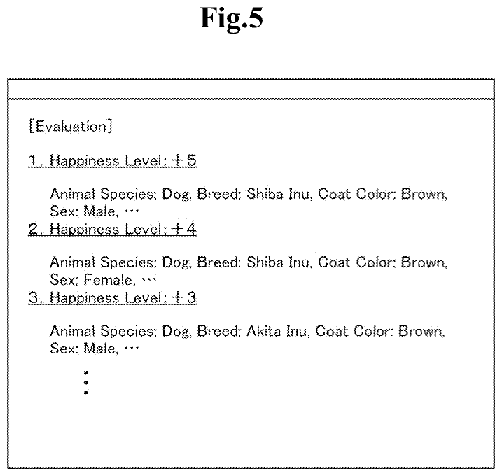

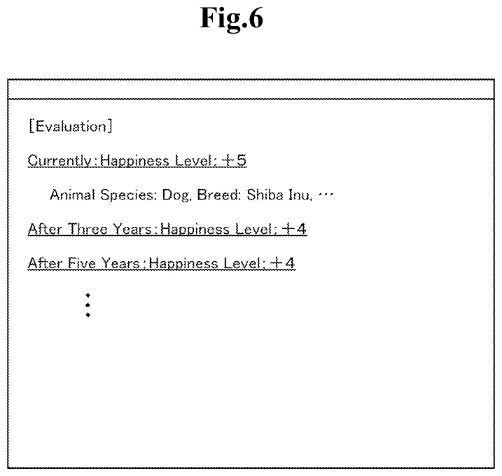

When pieces of desire data are generated from one piece of desire data inputted by one user and the evaluation unit 13 calculates evaluation values corresponding to the pieces of desire data, the output unit 14 outputs the evaluation values to the user terminal 1 such that the evaluation values are displayed on the user terminal 1 all at once. For example, the output unit 14 outputs the levels of happiness, which are evaluation values, and the pieces of desire data from which the levels of happiness have been calculated, such that the levels of happiness and the pieces of data are displayed in association with each other in the descending order of the levels of happiness. FIG. 5 shows a case in which multiple pieces of desire data are generated by changing “breed,” “sex,” or the like in desired pet information in one piece of desire data and the levels of happiness corresponding to the pieces of desire data are calculated. As shown in FIG. 5, the evaluation values corresponding to the pieces of desired pet information, that is, the evaluation values corresponding to animals that differ from each other in attributes such as “breed” or “sex” are presented to the user. Moreover, information on the animals from which the evaluation values have been calculated is displayed. Thus, an animal suitable for the user can be recommended on the basis of the evaluation values. Also, FIG. 6 shows a case in which multiple pieces of desire data are generated by changing a predetermined item in user information in one piece of desire data with respect to after three years and after five years and the levels of happiness corresponding to the pieces of desire data are calculated. As shown in FIG. 6, the evaluation values after several years are presented to the user, and animals suitable for the user after several years can be recommended.

### Operation

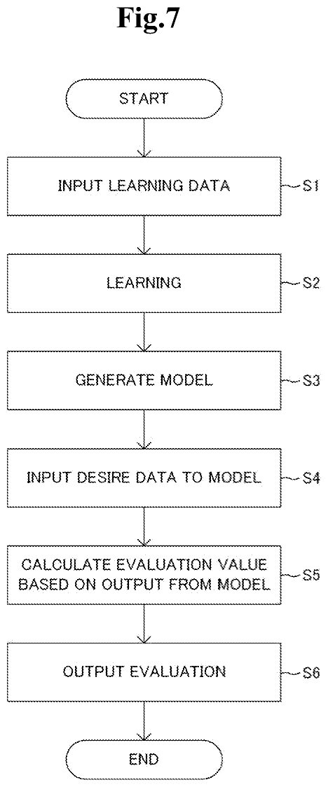

Next, an operation of the evaluation apparatus 10 will be described mainly with reference to the flowchart of FIG. 7. First, the evaluation apparatus 10 receives and stores input of learning data from the operator of the evaluation apparatus 10, or a different server (step S1). For example, the evaluation apparatus 10 receives and stores input of learning data including “pet information,” which is information on animals kept by keepers in the past, and “keeper information,” which is information on the keepers, as shown in FIG. 2. The “pet information” includes, for example, the species, breed, coat color, sex, date of birth, personality, condition, life span, and the like of the kept animals. The “keeper information” includes the keeping place (outdoors/indoors, width, local hospital, etc.), past keeping history (pet information (species, breed, etc.), medical history, life span (keeping years), etc.), family structure, occupation, sex, age, leisure time, annual income, moving history, and the like of the keepers of the animals.

The evaluation apparatus 10 then performs learning using learning data (step S2) and generates and stores a model that predicts the expected life span of an animal to be kept by the user (step S3). Specifically, the evaluation apparatus 10 learns from cases in which keepers have actually kept animals and generates a model that receives information such as the breed and personality of animals and the keeping place and keeping history of keepers as input data and outputs the life span of an actual animal as output data. That is, the evaluation apparatus 10 generates a model that receives information such as the breed and personality of animals and outputs the expected life span of an animal.

The evaluation apparatus 10 then receives and acquires input of desire information from the user of the user terminal 1 who desires to newly keep an animal and can become a keeper and inputs the desire data to the model (step S4). For example, the evaluation apparatus 10 receives input of desire data including “desired pet information,” which is information on an animal that the user desires to keep, and “user information,” which is information on the user, as shown in FIG. 3. For example, the “desired pet information” includes animal species (species information), breed, coat color, sex, date of birth, personality, condition, and the like as attribute information indicating the attributes of the animal that the user desires to keep. The “user information” includes keeping place (outdoors/indoors, width, local hospital, etc.), past keeping history (pet information (animal species, breed, etc.), medical history, life span (keeping years), etc.), family structure, occupation, sex, age, leisure time, annual income, the possibility of moving, and the like as keeping information indicating the keeping status of the user who desires to keep the animal.

At this time, the evaluation apparatus 10 may input only the received desire data to the model, or may generate multiple pieces of desire data by changing information on some items of the desire data and input the item-changed pieces of desire data to the model. For example, the evaluation apparatus 10 may generate multiple pieces of desire data by changing some items in the “desired pet information” in the desire data, that is, attribute information of the animal desired by the user and input the pieces of desire data to the model. Also, for example, the evaluation apparatus 10 may generate pieces of desire data by changing some items in “user information” in the desire data, that is, items such as the keeping place (outdoors/indoors, width, local hospital, etc.), “age,” and “family structure” of the user and input the pieces of desire data to the model.

The evaluation apparatus 10 then calculates an evaluation value indicating the evaluation of keeping of the animal by the user on the basis of an output from the model that has received the desire data (step S5). For example, the evaluation apparatus 10 acquires the expected life span of the animal outputted from the model that has received the desire data from the user and calculates the level of happiness of the user or animal as an evaluation value on the basis of the expected life span. More specifically, the evaluation apparatus 10 calculates the level of happiness of the animal using the formula [the expected life span of the animal)−(the predetermined reference life span of an animal of the same species)] and handles a higher value as a higher evaluation. Or, the evaluation apparatus 10 calculates the level of happiness of the user using the formula [the expected life span of the animal)−(the number of years of keeping of an animal in the past by the user)] and handles a higher value as a higher evaluation.

The evaluation apparatus 10 then outputs the calculated evaluation value to the user terminal 1 to display it on the display unit of the user terminal 1 (step S6). At this time, the evaluation apparatus 10 also displays information on an animal inputted to calculate the evaluation value so that this animals is recommended as an animal suitable for the user. For example, as shown in FIG. 4, the evaluation apparatus 10 outputs the calculated evaluation value “happiness level: +5” to display it, as well as outputs all or part of the desire data from which the evaluation value has been evaluated to display it. Also, as shown in FIG. 5, when the “breed,” “sex”,” and the like in the desired pet information in the inputted desire data are changed, the evaluation apparatus 10 may calculate the respective levels of happiness and output the calculated levels of happiness to display them. Also, as shown in FIG. 6, when the predetermined items in the user information in the inputted desire data are changed, the evaluation apparatus 10 may calculate the respective levels of happiness and may output the calculated levels of happiness to display them.

As described above, in the present example embodiment, the desire data of the user who desires to newly keep an animal is inputted to the model that has performed learning using the information on the keepers who have kept animals in the past. Thus, the evaluation value of keeping of the animal by the user is calculated. This allows the user to select an animal to be kept with reference to the evaluation value, as well as allows for animal selection suitable for both the user and the animal. Also, in the present example embodiment, the attributes of the animal that the user desires to keep, the user status, or the like are changed, and the respective the evaluation values are calculated. This allows the user to refer to the evaluation values corresponding to various animals or user status, as well as allows for animal selection suitable for both the user and the animal.

### Second Example Embodiment

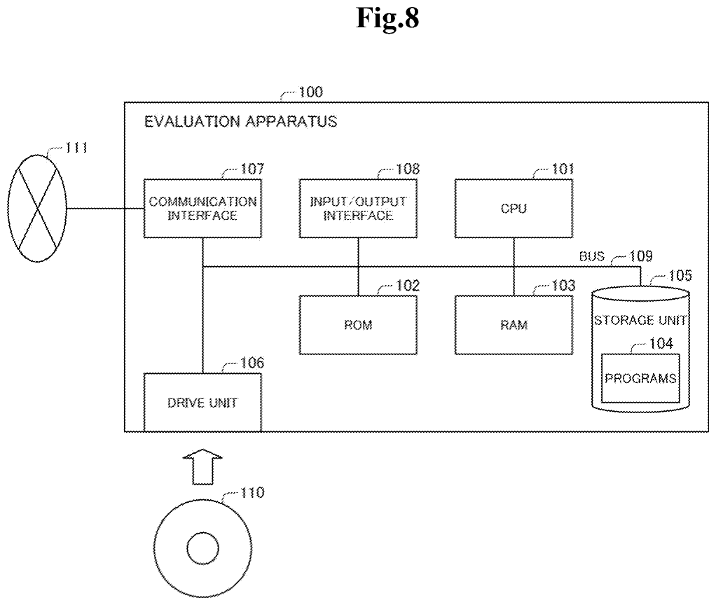

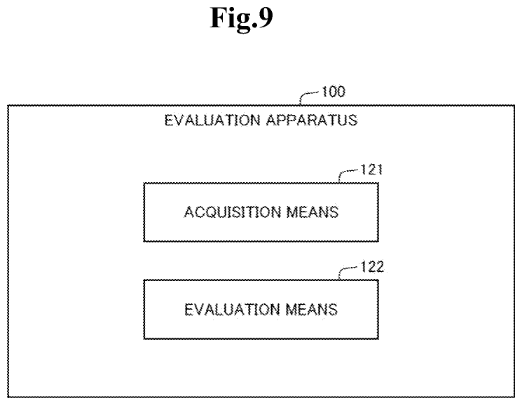

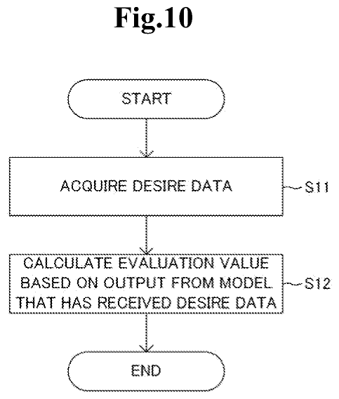

Next, a second example embodiment of the present invention will be described with reference to FIGS. 8 to 10. FIGS. 8 and 9 are block diagrams showing a configuration of an evaluation apparatus according to the second example embodiment. FIG. 10 is a flowchart showing an operation of the evaluation apparatus. In the present example embodiment, the configurations of the evaluation apparatus and evaluation method described in the above example embodiment are outlined.

First, a hardware configuration of an evaluation apparatus 100 according to the present example embodiment will be described with reference to FIG. 8. The evaluation apparatus 100 consists of a typical information processing apparatus and includes, for example, the following hardware components:
a CPU (central processing unit) 101 (arithmetic logic unit);
a ROM (read-only memory) 102 (storage unit);
a RAM (random-access memory) 103 (storage unit);
programs 104 loaded into the RAM 103;
a storage unit 105 storing the programs 104;
a drive unit 106 that writes and reads to and from a storage medium 110 outside the information processing apparatus;
a communication interface 107 that connects with a communication network 111 outside the information processing apparatus;
an input/output interface 108 through which data is inputted and outputted; and
a bus 109 through which the components are connected to each other.

When the CPU 101 acquires and executes the programs 104, acquisition means 121 and evaluation means 122 shown in FIG. 9 are implemented in the evaluation apparatus 100. For example, the programs 104 are previously stored in the storage unit 105 or ROM 102, and the CPU 101 loads and executes them into the RAM 103 when necessary. The programs 104 may be provided to the CPU 101 through the communication network 111. Also, the programs 104 may be previously stored in the storage medium 110, and the drive unit 106 may read them therefrom and provide them to the CPU 101. Note that the acquisition means 121 and evaluation means 122 may be implemented by a dedicated electronic circuit for implementing these means.

The hardware configuration of the information processing apparatus serving as the evaluation apparatus 100 shown in FIG. 8 is illustrative only and is not limiting. For example, the information processing apparatus does not have to include one or some of the above components such as the drive unit 106.

The evaluation apparatus 100 performs an evaluation method shown in the flowchart of FIG. 20 using the functions of the acquisition means 121 and evaluation means 122 implemented on the basis of the programs as described above.

As shown in FIG. 10, the evaluation apparatus 100 performs the following steps: acquiring desire data including information on a desired animal, which is an animal that a user desires to keep, and information on the user (step S11); and
inputting the desire data to a model, the model being generated by learning learning data including information on a kept animal being an animal kept by a keeper and information on the keeper, and calculating an evaluation value indicating an evaluation of keeping of the animal by the user on the basis of information calculated by the model (step S12).

The present invention thus configured inputs the desire data of the user who desires to newly keep an animal to the model that has performed learning using the information on the keepers who have kept animals in the past and calculates the evaluation value of keeping of the animal by the user. This allows the user to select an animal with reference to the evaluation value, as well as allows for animal selection that is suitable for both the user and the animal.

The above programs may be stored in various types of non-transitory computer-readable media and provided to a computer. The non-transitory computer-readable media include various types of tangible storage media. The non-transitory computer-readable media include, for example, a magnetic recording medium (for example, a flexible disk, a magnetic tape, a hard disk drive), a magneto-optical recording medium (for example, a magneto-optical disk), a CD-ROM (read-only memory), a CD-R, a CD-R/W, and a semiconductor memory (for example, a mask ROM, a PROM (programmable ROM), an EPROM (erasable PROM), a flash ROM, a RAM (random-access memory)). The programs may be provided to a computer by using various types of transitory computer-readable media. The transitory computer-readable media include, for example, an electric signal, an optical signal, and an electromagnetic wave. The transitory computer-readable media can provide the programs to a computer via a wired communication channel such as an electric wire or optical fiber, or via a wireless communication channel.

While the present invention has been described with reference to the above-mentioned example embodiments and so on, the present invention is not limited to the example embodiments. The configuration or details of the present invention can be changed in various manners that can be understood by one skilled in the art within the scope of the present invention. At least one of the functions of the acquisition means 121 and evaluation means 122 may be performed by an information processing apparatus placed at and connected to any place on the network, that is, may be performed by co-called cloud computing.

### Supplementary Notes

Some or all of the embodiments can be described as in Supplementary Notes below. While configurations of the evaluation method, evaluation apparatus, and program according to the present invention are outlined below, the present invention is not limited thereto.

### Supplementary Note 1

An evaluation method comprising:
acquiring desire data including information on a desired animal being an animal that an user desires to keep and information on the user; and
inputting the desire data to a model, the model being generated by learning learning data including information on a kept animal being an animal kept by a keeper and information on the keeper, and calculating an evaluation value indicating an evaluation of keeping of the animal by the user on the basis of information calculated by the model.

### Supplementary Note 2

The evaluation method of Supplementary Note 1, wherein the inputting the desire data to the model and the calculating the evaluation value comprise inputting the desire data to the model, the model being generated by learning the learning data including the information on the kept animal including a life span of the kept animal, and calculating the evaluation value on the basis of an expected life span of the animal to be kept by the user calculated by the model.

### Supplementary Note 3

The evaluation method of Supplementary Note 2, wherein the calculating the evaluation value comprises calculating the evaluation value on the basis of the expected life span of the animal to be kept by the user calculated by the model and a predetermined reference life span of an animal of the same species as the animal to be kept by the user.

### Supplementary Note 4

The evaluation method of Supplementary Note 2 or 3, wherein the calculating the evaluation value comprises calculating the evaluation value on the basis of the expected life span of the animal to be kept by the user calculated by the model and the number of years of keeping of an animal in the past by the user included in the information on the user.

### Supplementary Note 5

The evaluation method of any one of Supplementary Notes 1 to 4, wherein the inputting the desire data to the model and the calculating the evaluation value comprise inputting a plurality of pieces of desire data to the model, the pieces of desire data being generated by changing some information in the desire data, and calculating a plurality of evaluation values corresponding to the pieces of desire data.

### Supplementary Note 6

The evaluation method of Supplementary Note 5,
wherein the information on the desired animal included in the desire data includes attribute information indicating an attribute of the desired animal, and
wherein the inputting the desire data to the model and the calculating the evaluation value comprise inputting a plurality of pieces of desire data to the model, the pieces of desire data being generated by changing the attribute information in the information on the desired animal in the desire data, and calculating a plurality of evaluation values corresponding to the pieces of desire data.

### Supplementary Note 7

The evaluation method of Supplementary Note 6, wherein the attribute information is species information indicating a species of the desired animal.

### Supplementary Note 8

The evaluation method of any one of Supplementary Notes 5 to 7,
wherein the information on the user included in the desire data includes keeping information indicating a keeping status of the user, and
wherein the inputting the desire data to the model and the calculating the evaluation value comprise inputting a plurality of pieces of desire data to the model, the pieces of desire data being generated by changing the keeping information in the information on the user included in the desire data, and calculating a plurality of evaluation values corresponding to the pieces of desire data.

### Supplementary Note 9

The evaluation method of Supplementary Note 8, wherein the keeping information includes information indicating a predicted future keeping status of the user.

### Supplementary Note 10

An evaluation apparatus comprising:
acquisition means configured to acquire desire data including information on a desired animal being an animal that an user desires to keep and information on the user; and
evaluation means configured to input the desire data to a model, the model being generated by learning learning data including information on a kept animal being an animal kept by a keeper and information on the keeper, and to calculate an evaluation value indicating an evaluation of keeping of the animal by the user on the basis of information calculated by the model.

### Supplementary Note 11

The evaluation apparatus of Supplementary Note 10, wherein the evaluation means inputs the desire data to the model, the model being generated by learning the learning data including the information on the kept animal including a life span of the kept animal, and calculates the evaluation value on the basis of an expected life span of the animal to be kept by the user calculated by the model.

### Supplementary Note 12

The evaluation apparatus of Claim 11, wherein the evaluation means calculates the evaluation value on the basis of the expected life span of the animal to be kept by the user calculated by the model and a predetermined reference life span of an animal of the same species as the animal to be kept by the user.

### Supplementary Note 13

The evaluation apparatus of Supplementary Note 11 or 12, wherein the evaluation means calculates the evaluation value on the basis of the expected life span of the animal to be kept by the user calculated by the model and the number of years of keeping of an animal in the past by the user included in the information on the user.

### Supplementary Note 14

The evaluation apparatus of any one of Supplementary Notes 10 to 13, wherein the evaluation means inputs a plurality of pieces of desire data to the model, the pieces of desire data generated by changing some information in the desire data, and calculates a plurality of evaluation values corresponding to the pieces of desire data.

### Supplementary Note 15

The evaluation apparatus of Supplementary Note 14, wherein the information on the desired animal included in the desire data includes attribute information indicating an attribute of the desired animal, and wherein the evaluation means inputs a plurality of pieces of desire data to the model, the pieces of desire data being generated by changing the attribute information in the information on the desired animal in the desire data, and calculates a plurality of evaluation values corresponding to the pieces of desire data.

### Supplementary Note 16

The evaluation apparatus of Supplementary Note 14 or 15,
wherein the information on the user included in the desire data includes keeping information indicating a keeping status of the user, and
wherein the evaluation means inputs a plurality of pieces of desire data to the model, the pieces of desire data being generated by changing the keeping information in the information on the user included in the desire data, and calculates a plurality of evaluation values corresponding to the pieces of desire data.

### Supplementary Note 17

A program for causing an information processing apparatus to function as:
acquisition means configured to acquire desire data including information on a desired animal being an animal that an user desires to keep and information on the user; and
evaluation means configured to input the desire data to a model, the model being generated by learning learning data including information on a kept animal being an animal kept by a keeper and information on the keeper, and to calculate an evaluation value indicating an evaluation of keeping of the animal by the user on the basis of information calculated by the model.

### REFERENCE SIGNS LIST

1 user terminal
10 evaluation apparatus
11 input unit
12 learning unit
13 evaluation unit
14 output unit
15 learning data storage unit
16 model storage unit
17 pet data storage unit
100 evaluation apparatus
101 CPU
102 ROM
103 RAM
104 programs
105 storage unit
106 drive unit
107 communication interface
108 input/outside interface
109 bus
110 storage medium
111 communication network
121 acquisition means
122 evaluation means

What is claimed is:

1. An evaluation method comprising:
acquiring desire data including information on a desired animal being an animal that an user desires to keep and information on the user; and
inputting the desire data to a model, the model being generated by learning learning data including information on a kept animal being an animal kept by a keeper and information on the keeper, and calculating an evaluation value indicating an evaluation of keeping of the animal by the user on the basis of information calculated by the model.

2. The evaluation method of claim 1, wherein the inputting the desire data to the model and the calculating the evaluation value comprise inputting the desire data to the model, the model being generated by learning the learning data including the information on the kept animal including a life span of the kept animal, and calculating the evaluation value on the basis of an expected life span of the animal to be kept by the user calculated by the model.

3. The evaluation method of claim 2, wherein the calculating the evaluation value comprises calculating the evaluation value on the basis of the expected life span of the animal to be kept by the user calculated by the model and a predetermined reference life span of an animal of the same species as the animal to be kept by the user.

4. The evaluation method of claim 2, wherein the calculating the evaluation value comprises calculating the evaluation value on the basis of the expected life span of the animal to be kept by the user calculated by the model and the number of years of keeping of an animal in the past by the user included in the information on the user.

5. The evaluation method of claim 1, wherein the inputting the desire data to the model and the calculating the evaluation value comprise inputting a plurality of pieces of desire data to the model, the pieces of desire data being generated by changing some information in the desire data, and calculating a plurality of evaluation values corresponding to the pieces of desire data.

6. The evaluation method of claim 5,
wherein the information on the desired animal included in the desire data includes attribute information indicating an attribute of the desired animal, and
wherein the inputting the desire data to the model and the calculating the evaluation value comprise inputting a plurality of pieces of desire data to the model, the pieces of desire data being generated by changing the attribute information in the information on the desired animal in the desire data, and calculating a plurality of evaluation values corresponding to the pieces of desire data.

7. The evaluation method of claim 6, wherein the attribute information is species information indicating a species of the desired animal.

8. The evaluation method of claim 5,
wherein the information on the user included in the desire data includes keeping information indicating a keeping status of the user, and
wherein the inputting the desire data to the model and the calculating the evaluation value comprise inputting a plurality of pieces of desire data to the model, the pieces of desire data being generated by changing the keeping information in the information on the user included in the desire data, and calculating a plurality of evaluation values corresponding to the pieces of desire data.

9. The evaluation method of claim 8, wherein the keeping information includes information indicating a predicted future keeping status of the user.

10. An evaluation apparatus comprising:
at least one memory configured to store instructions; and
at least one processor configured to execute instructions to:
acquire desire data including information on a desired animal being an animal that an user desires to keep and information on the user; and
input the desire data to a model, the model being generated by learning learning data including information on a kept animal being an animal kept by a keeper and information on the keeper, and calculate an evaluation value indicating an evaluation of keeping of the animal by the user on the basis of information calculated by the model.

11. The evaluation apparatus of claim 10, wherein the at least one processor is configured to input the desire data to the model, the model being generated by learning the learning data including the information on the kept animal including a life span of the kept animal, and to calculate the evaluation value on the basis of an expected life span of the animal to be kept by the user calculated by the model.

12. The evaluation apparatus of claim 11, wherein the at least one processor is configured to calculate the evaluation value on the basis of the expected life span of the animal to be kept by the user calculated by the model and a predetermined reference life span of an animal of the same species as the animal to be kept by the user.

13. The evaluation apparatus of claim 11, wherein the at least one processor is configured to calculate the evaluation value on the basis of the expected life span of the animal to be kept by the user calculated by the model and the number of years of keeping of an animal in the past by the user included in the information on the user.

14. The evaluation apparatus of claim 10, wherein the at least one processor is configured to input a plurality of pieces of desire data to the model, the pieces of desire data being generated by changing some information in the desire data, and to calculate a plurality of evaluation values corresponding to the pieces of desire data.

15. The evaluation apparatus of claim 14,
wherein the information on the desired animal included in the desire data includes attribute information indicating an attribute of the desired animal, and
wherein the at least one processor is configured to input a plurality of pieces of desire data to the model, the pieces of desire data being generated by changing the attribute information in the information on the desired animal in the desire data, and to calculate a plurality of evaluation values corresponding to the pieces of desire data.

16. The evaluation apparatus of claim 14,
wherein the information on the user included in the desire data includes keeping information indicating a keeping status of the user, and
wherein the at least one processor is configured to input a plurality of pieces of desire data to the model, the pieces of desire data being generated by changing the keeping information in the information on the user included in the desire data, and to calculate a plurality of evaluation values corresponding to the pieces of desire data.

17. A non-transitory computer-readable storage medium storing a program for causing an information processing apparatus to perform the steps of:
acquiring desire data including information on a desired animal being an animal that an user desires to keep and information on the user; and
inputting the desire data to a model, the model being generated by learning learning data including information on a kept animal being an animal kept by a keeper and information on the keeper, and calculating an evaluation value indicating an evaluation of keeping of the animal by the user on the basis of information calculated by the model.
